(19) United States
(12) Patent Application Publication
(10) Pub. No.: US 2004/0177138 A1
(43) Pub. Date: Sep. 9, 2004

(54) Method and system for processing user feedback received from a user of a website

(76) Inventors: Mathias Salle, Palo Alto, CA (US); Evan Kirshenbaum, Mountain View, CA (US); Cipriano Santos, Modesto, CA (US)

Correspondence Address: HEWLETT-PACKARD COMPANY, Intellectual Property Administration, P.O. Box 272400, Fort Collins, CO, 80527-2400, US

(21) Appl. No.: 10/378,823

(22) Filed: Mar. 5, 2003

(51) Int. Cl. G06F 15/173

(52) U.S. Cl. 709/223; 715/501.1

(57) ABSTRACT

A method is disclosed for processing feedback from a user of a website. Feedback is received from the user relating to a current session of use of the website. Based on the feedback, a problem is diagnosed. Compensation for the user is determined, based on the problem, and the user is compensated at the level determined to be appropriate for the problem.

### CROSS-REFERENCE TO RELATED APPLICATIONS

This application is related to U.S. patent application Ser. No. 10/______ (Attorney Docket No. 200207986-1), entitled “METHOD AND SYSTEM FOR EVALUATING PERFORMANCE OF A WEBSITE USING A CUSTOMER SEGMENT AGENT TO INTERACT WITH THE WEBSITE ACCORDING TO A BEHAVIOR MODEL” to Cipriano SANTOS, et al.; U.S. patent application Ser. No. 10/------ (Attorney Docket No. 200207987-1), entitled “METHOD AND SYSTEM FOR CUSTOMIZED CONFIGURATION OF AN APPEARANCE OF A WEBSITE FOR A USER” to Evan KIRSHENBAUM, et al.; U.S. patent application Ser. No. 10/------ (Attorney Docket No. 200207988-1), entitled “SYSTEM, METHOD AND APPARATUS USING BIOMETRICS TO COMMUNICATE CUSTOMER DISSATISFACTION VIA STRESS LEVEL” to Carol McKENNAN, et al.; U.S. patent application Ser. No. 10/------ (Attorney Docket No. 200207991-1), entitled “APPARATUS AND METHOD FOR THEOREM CERTIFICATION WITHOUT DISCLOSING DOCUMENTS THAT LEAD TO THE THEOREM” to Mathias SALLE; U.S. patent application Ser. No. 10/------ (Attorney Docket No. 200207993-1), entitled “METHOD AND SYSTEM FOR SELLING AN ITEM OVER A COMPUTER NETWORK” to Evan KIRSHENBAUM, et al.; U.S. patent application Ser. No. 10/------ (Attorney Docket No. 200207994-1), entitled “METHOD AND SYSTEM ENABLING THE TRADING OF A RIGHT TO PURCHASE GOODS OR SERVICES” to Robert C. VACANTE, et al., and U.S. patent application Ser. No. 10/------ (Attorney Docket No. 200309361-1), entitled “A METHOD AND SYSTEM ENABLING THE TRADING OF A FUTURES CONTRACT FOR THE PURCHASE OF GOODS OR SERVICES” to Robert C. VACANTE, et al., all of which are concurrently herewith being filed under separate covers, the subject matters of which are herein incorporated by reference.

### TECHNICAL FIELD

The technical field relates generally to software for management of computer networks. More particularly, the technical field relates to a method and system for processing user feedback received from a user of a website.

### BACKGROUND

In the field of computer network management, it is desirable to for administrators of websites to receive feedback from their users and to process this feedback promptly to ensure satisfied users. This is particularly true of retail websites that offer for sale goods or services to regular and loyal customers. It is more difficult to retain existing Internet customers than it is to attract those customers in the first instance. Existing customers often leave websites due to the inability to provide feedback to the service provider and the non-responsiveness of existing website systems for managing and responding to feedback.

One problem with existing feedback processing systems is that they apply the same feedback processing to all users, regardless of the particular user's needs and background. To receive personalized service regarding a website problem, users must often call a telephone number for technical support. Many users are reluctant to spend their time waiting for live interaction with an operator. As a result, users simply remain unhappy with the service received by the website, and service providers of such websites lose those unhappy users' business. Also, existing systems ignore the source of the user's problem and provide no means of addressing the particular problems encountered by the user. What is needed is a more effective and user-specific way of processing feedback from users of a website.

### SUMMARY

A method is disclosed for processing feedback from a user of a website. Feedback is received from the user relating to a current session of use of the website. Based on the feedback, a problem is diagnosed. Compensation for the user is determined, based on the problem, and the user is compensated at the level determined to be appropriate for the problem.

A tangible computer-readable medium is also disclosed having computer-executable instructions for performing a method for processing feedback from a user of a website. Service management data is collected from a current session of use of the website by the user. Feedback is related from the user based on the current session. Based on the feedback and service management data, a problem with the website is diagnosed. Compensation is determined for the user based on the nature of the problem and the value of the user to the website.

A computer-based website is also disclosed that executes instructions for performing a method of compensating a user of the website based on feedback reported by the user. Feedback is received from the user during a current session of use of the website. A problem with the website is diagnosed based on the feedback. Compensation for the user is determined based on the problem. To determine compensation, the website assesses the cost of the problem to the user and determines whether the cost to the user exceeds a threshold value. Compensation is proposed to the user if the cost exceeds the threshold value.

### DESCRIPTION OF THE DRAWINGS

The detailed description will refer to the following drawings, wherein like numerals refer to like elements, and wherein:

FIG. 1 shows a block diagram of a computer system that implements a customer feedback system;

FIG. 2 shows a flow chart of a method of processing feedback received from a user of a website;

FIG. 3 shows a more detailed flow chart of a method of processing user feedback from a user of a website; and

FIG. 4 shows a flow chart of one implementation of the step of requesting feedback from the user, shown in FIG. 3.

### DETAILED DESCRIPTION

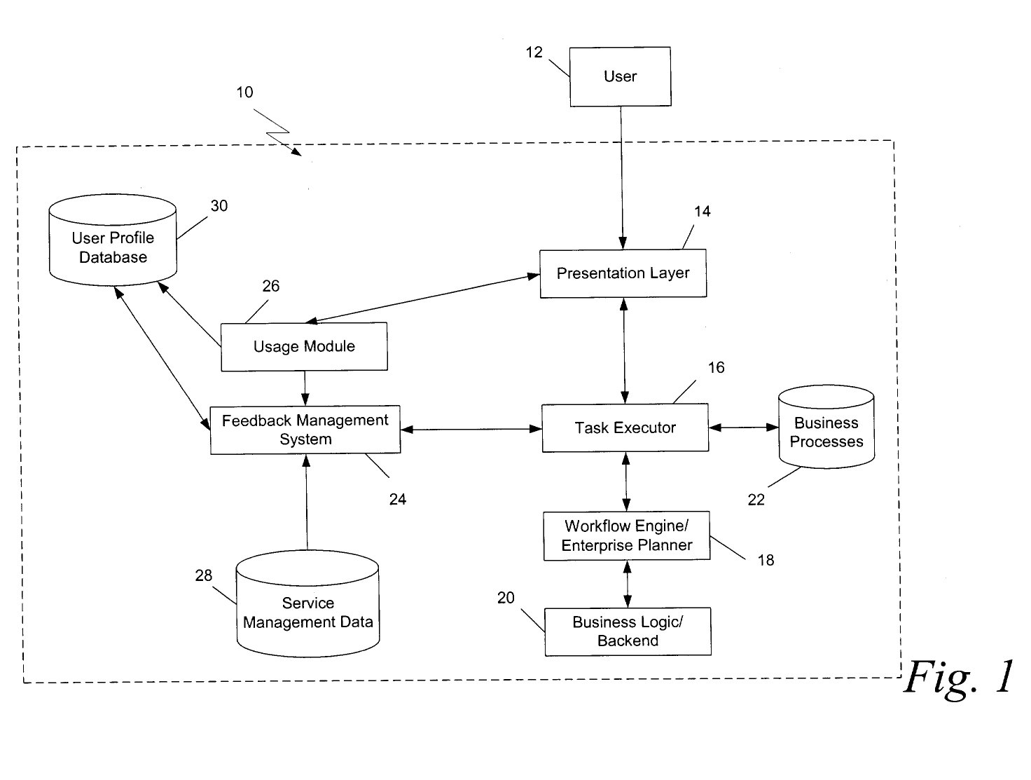

FIG. 1 is a block diagram of a computer system 10 that processes feedback from a user of a website. As shown in FIG. 1, a user 12 accesses a presentation layer 14 of the website. As used herein, the presentation layer refers to any user interface portion of the website. The presentation layer 14 may be a graphical user interface (GUI) and may include multiple, linked web pages that can be traversed by the user 12, for example, using hyperlinks or menus displayed on the individual pages. A usage module 26 receives service management data from the presentation layer 14, based on the user's interactions with the presentation layer 14. A user profile database 30 stores user data related to the user 12 and other users of the website. The user profile database 30 receives data from the usage module 26, such that specific service management data for the user 12 is stored to a profile created in the user profile database 30, for the user 12.

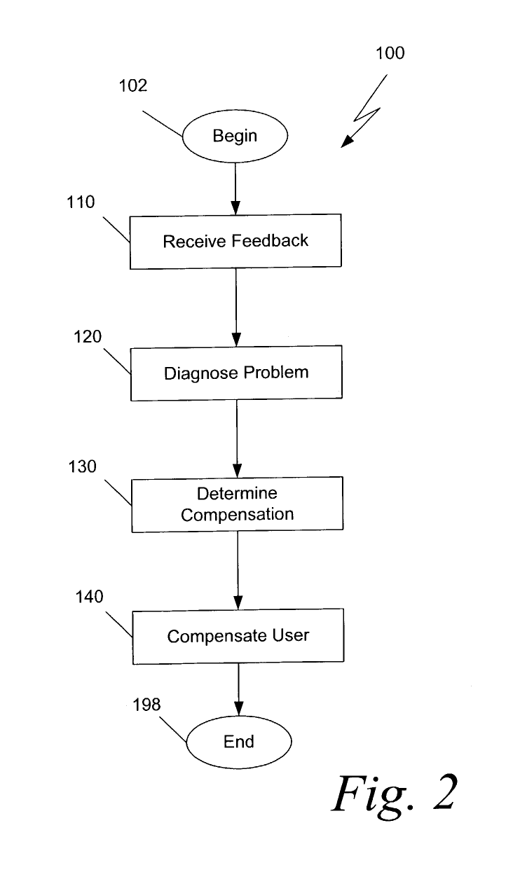

The business processes database 22 stores data related to the business processes performed by the website, as executed by the presentation layer 14. The task executor 16 executes the business processes in the business process database 22. The task executor 16 also sends instructions from the feedback management system 24 to the presentation layer 14. The feedback management system 24 controls the processing of user feedback, as described with respect to FIGS. 2-4 herein.

The service management database 28 stores service management data related to the user's current session of use of the website. The service management data includes log data showing the user's interactions with the presentation layer 14. In one embodiment, the service management database 28 stores service management data for all of the transactions by all users of the website. Data particular to the user 12 is also stored in the user's profile in the user profile database 30, for example, by storing the service management data directly to the user profile or by storing a pointer to the location of the data in the service management database 28, or by using another cross-reference. By including the service management data in the user's profile, the system 10 better tracks the user's usage habits related to the website. Usage habits include things such as the frequency of use of the website, the average duration of use, whether the user 12 frequently purchases items on the website or simply browses, the time(s) of day the user normally accesses the website, the types and price range of items or services viewed by the user, etc.

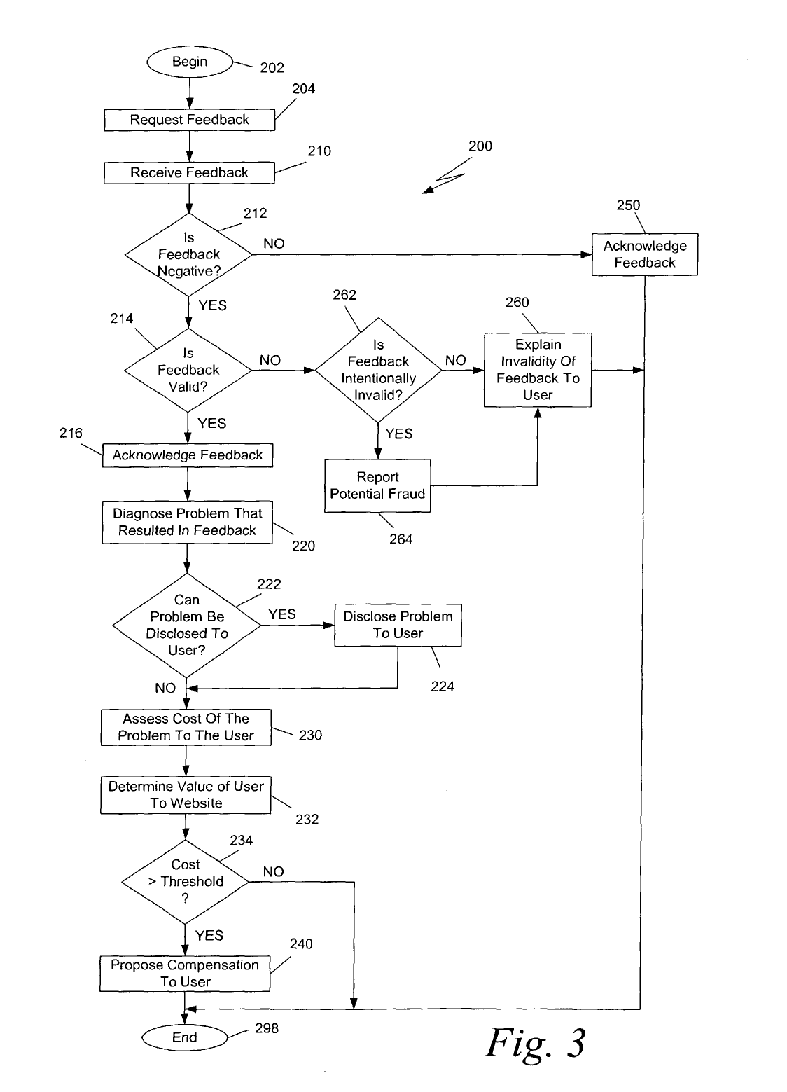

In one embodiment, the system 10 uses user models to characterize the user 12, based on the user's usage habits. As explained herein with respect to FIGS. 2 and 3, the feedback management system 24 processes feedback differently for different users. One method of differentiating between users is to group users based on their usage habits and other data in the user profile, and to process feedback received from different groups of users differently. For example, one group of users might include those who access the website more frequently, spend more money on website goods and/or services, are more loyal to the service provider, etc. compared to other users. The feedback management system 24 may then be more responsive to feedback received from members of this “better” group of users than it is to new or infrequent users of the website, with the objective of retaining valued customers.

In one embodiment, the groups are enumerated by an owner of the website or some other individual. In another embodiment, groups are discovered by an algorithm that discovers similarities among data collected regarding different users. In one embodiment, a user is assigned to specific group as a result of hand-crafted rules that consult data collected regarding the user. In another embodiment, a user is assigned to a specific group as a result of rules algorithmically discovered using a data mining process.

In yet another embodiment, the system 10 contains a notion of “responsiveness level,” which is a numeric value or other ordered value. In one embodiment, the system 10 computes the responsiveness level appropriate for a user based on a hand-crafted function that takes as parameters data collected regarding that user. In another embodiment, the system 10 computes the responsiveness level appropriate for a user based on rules discovered during a data mining process.

The feedback management system 24 and the business processes 22 of the website are implemented by a task executor 16. In one embodiment, the feedback management system 24 requests feedback from the user 12 upon the completion of certain tasks by the user 12. The tasks are part of the business processes operating on the website and are stored in the business processes database 22. For example, the feedback management system 24 may request feedback when the user 12 completes a transaction with the website, or when the user 12 attempts to abort a transaction. In one embodiment, certain tasks in the business processes database 22 are marked, or “tagged,” by the feedback management system 24 to automatically request feedback from the user 12 upon completion of the task. Upon completion of tasks that are not tagged for feedback, the feedback management system 24 may still request feedback if it would be desirable to obtain additional feedback information from the user 12. For example, it may be desirable to obtain additional user information if the user's user profile is incomplete or has not recently been updated.

The workflow engine/enterprise planner 18 divides tasks into subtasks and controls execution of the tasks. The business logic and backend 20 support the presentation layer 14 of the system 10. The business logic and backend 12 access the data in the business processes database 22 and interface with the presentation layer 14 to present the business processes data to the presentation layer 14 in the proper format.

FIG. 2 shows a flow chart of a method 100 of processing feedback received from a user of a website. During a current session of the user's use of the website, the method 100 begins 102 and feedback is received 110, for example, in response to a request from the system 10. Based on the feedback, the system 10 diagnoses 120 a problem perceived by the user 12, with the current website session. Based on the nature of the problem, the system 10 determines 130 appropriate compensation for the user 12. The user 12 is then compensated 140 based on the determined compensation, and the method 100 ends 198.

Compensation will vary depending upon the exact nature of the problem and the website. For example, compensation at a website that sells goods or services, such as books, electronics, sporting goods, hotel accommodations, air travel tickets, etc. might include a coupon for future purchases or other special offer. Other forms of compensation might include other discount certificates or offers, “minutes” on a website that charges for network-based services on a per-minute basis, “points” on a website that maintains accounts of users' loyalty points, such as frequent flier miles.

In one embodiment, compensation is provided in the form of a promise or guarantee of improved website performance in the future. In one context, the guarantee is an informal request that the user 12 continue to use the website. In another context, the guarantee also includes a discount or similar reward if future service does not improve. In a more formal context, a service level agreement (SLA) may control the user's access to the website. As part of the guarantee, the SLA may be automatically modified to guarantee improved future service, for example, by increasing the user's bandwidth, level of access, duration of access, or any other feature of the SLA. For websites that offer premium services, the guarantee may also upgrade the user's access to include the premium services on a temporary or permanent basis.

FIG. 3 shows a more detailed flow chart of a method 200 of processing user feedback from a user 12 of a website, received during a current session of use of the website. The method 200 begins 202 by requesting 204 feedback from the user 12. Feedback may be requested 204, for example, by prompting the user 12 for feedback using a dialog box or otherwise displaying a request for feedback on the website during the current session. In one embodiment, feedback may be received using a separate feedback web page that may be displayed in a separate window or portion of the user's display. In the embodiment of FIG. 3, the system 10 receives 210 the user's feedback and determines whether the feedback is negative 212. In this example, only negative feedback is processed. If the feedback is not negative, then the system 10 acknowledges 250 the user's feedback and the method 200 ends 298. Feedback may be acknowledged by displaying a message on the user's display indicating that the feedback has been received.

If the feedback is negative (“yes” branch at block 212), then the system 10 determines whether the feedback is valid 214. Feedback is considered invalid if the feedback relates to any problem that the website does not intend to compensate, regardless of the potential cost to the user 12 or the user's value to the website. One example of invalid feedback is feedback that relates to a problem that the website cannot fix or does not intend to fix. Another example of invalid feedback is feedback that results from a clear user error, whether the error is accidental or intentional. A system 10 that compensates users 12 who provide negative feedback may create an incentive for users 12 to fraudulently access the website for the purpose of simply obtaining compensation. In the example of FIG. 3, if the feedback is not valid (“no” branch at block 214), then the system 10 determines 262 whether the feedback might be intentionally invalid in order to detect potential fraud. In this example, if the feedback is intentionally invalid (“yes” branch at block 262), the system 10 reports the potential fraud. The reporting 264 may be done by sending an alert, such as an email message, to a system administrator. In another embodiment, the reporting 264 includes storing information related to the user 12 and the feedback, so that the stored information can be used to recognize users 12 who regularly or systematically access the website to provide intentionally invalid feedback.

After detecting invalid feedback, the system 10 explains to the user 12 that the feedback is invalid 260, and the method 200 ends 298. In one embodiment, when feedback is invalid (“no” branch at block 214), the user 12 is given details explaining why the feedback is incorrect. In one embodiment, when the system 10 determines that the user 12 has provided intentionally invalid feedback (“yes” branch at block 262) the step of explaining that the feedback is invalid 260 instructs the user 12 to stop providing intentionally invalid feedback.

If the feedback is valid (“yes” branch at block 214), then the system 10 acknowledges the feedback 216 and proceeds to diagnose the problem 220. In one embodiment, the system 10 records and stores service management data for the user's current session of use of the website. The service management data provides a history of the actions taken by the user 12 during the current session of use. By reviewing the service management data, the system 10 attempts to determine what caused the user 12 to express negative feedback. By way of example, the service management data might indicate that the user 12 repeatedly attempted the same transaction, or visited the same handful of pages of the website an unusual number of times, or could not access certain data or pages on the website due to high demand or technical difficulties, or could not purchase the desired goods or services.

Based on the diagnosis, the system 10 determines 222 whether the problem can be disclosed to the user 12. It may be desirable to explain to the user 12 the nature of the problem so that the user 12 is better informed. In the embodiment shown in FIG. 3, system 10 has the option of disclosing 224 the problem to the user 12 if the problem is one that the system has specified should be disclosed (“yes” branch at block 222), or not disclosing the problem (“no” branch at block 222), for example, if the nature of the problem should not be disclosed.

In one embodiment, the website is accessed by the service provider's own employees or agents. For example, the website may be entirely internal for use only by employees or may be accessed by both the general public and the service provider's employees. In such an example, it may be desirable to disclose the nature of certain problems only to employees or only to particular classes of employees having appropriate security clearances. The nature of the problem might be kept concealed from other employees or from the general public.

The system 10 then determines the cost of the problem to the user 230 and determines the value of the user to the website 232. These steps 230, 232 may be performed independently or may be intertwined. In one use, the method 200 is implemented to attempt to retain users of the website. In one embodiment, the system 10 determines the cost of the problem based on the particular user 12, using previously collected user data. The system 10 maintains user data that better identifies each user 12. The user data may vary for each website and may be included in the user profile stored in the database 30. In one embodiment, the user data includes personal information regarding the user 12, such as name, address, telephone number, personal preferences for interacting with the website, etc. In the example of an airline reservations system website, the user profile might also include information such as the user's frequent flier number or other loyalty club information, seat and meal preferences, preferred home airport, preferred credit card and credit card information, etc. In one embodiment, the system 10 gathers user data when the user 12 accesses the website, and the user data includes information such as the frequency with which the user 12 accesses the site, the frequency with which the user 12 purchases goods or services from the site, and the user's buying habits, such as the average amount of money spent by the user 12 using the website (e.g., for e-commerce websites). In other e-commerce embodiments, the website also retrieves user data indicating the type of products viewed by the user 12. This information would indicate user characteristics, such as the user's interests and hobbies, and whether the user 12 is browsing expensive or inexpensive goods.

Based on the user data, the system 10 can determine the value of the user 12 to the website 232. For example, the website may consider those users who regularly spend a lot of money at the website to be more valuable than those who spend little money at the website or simply browse. Certain users may be considered to have no value. For example, automated users, sometimes referred to as “robots” or “web crawlers,” that access websites without purchasing items and without performing meaningful transactions may be considered less valuable. The value of the user 12 is used, in part, to determine compensation for problems with the website, in one embodiment.

The system 10 uses the user data to more accurately determine the impact, or “cost”, of the problem on the user. For example, a user of an airline reservation website who books numerous reservations and who has earned significant frequent flier miles might be more affected by an inability to access the website than would be a user who merely browses the website, makes few reservations, and has a smaller frequent flier account balance. The former user might be more inclined to switch to a more reliable website, if he or she encounters substantial or frequent difficulties without compensation; whereas, the latter user may be merely browsing and therefore may be more tolerant of occasional interruptions of service. Also, the implementation of the method 200 may be designed to retain valued customers. The service provider of the website has a greater interest in satisfying the frequent user, than in satisfying the less-frequent user, and thus might conclude that the problem is more significant to the frequent user.

After determining the impact, or “cost,” of the problem to the user 12 and the value of the user 12 to the website, the system 10 determines whether the cost exceeds a threshold value 234 specified by the system 10. Depending upon the calculation of the cost, the system 10 may conclude that the problem does not merit compensation because it does not exceed the pre-defined threshold. If the problem does not merit compensation (“no” branch at block 234), then no compensation is offered to the user 12 and the method 200 ends 298. In one implementation, the threshold may vary for different users based upon the determining of the value of the users (e.g., 12) to the website 232. In this embodiment, the compensation system is more responsive to feedback from “better” customers (e.g., those users who visit the website or spend more money on the service provider's services than other users). To make the compensation system more responsive, the system 10 may determine a value of the user 12 to the website based on the user's user data. Higher valued customers may warrant higher compensation, and/or the threshold level of cost to the user 12 may be lowered in determining whether compensation is appropriate. If the cost to the user 12 exceeds the threshold value, then the system 10 proposes compensation to the user 240, for example, by sending the user an email message or by displaying the compensation on the website during the user's current session. The method 200 then ends 298.

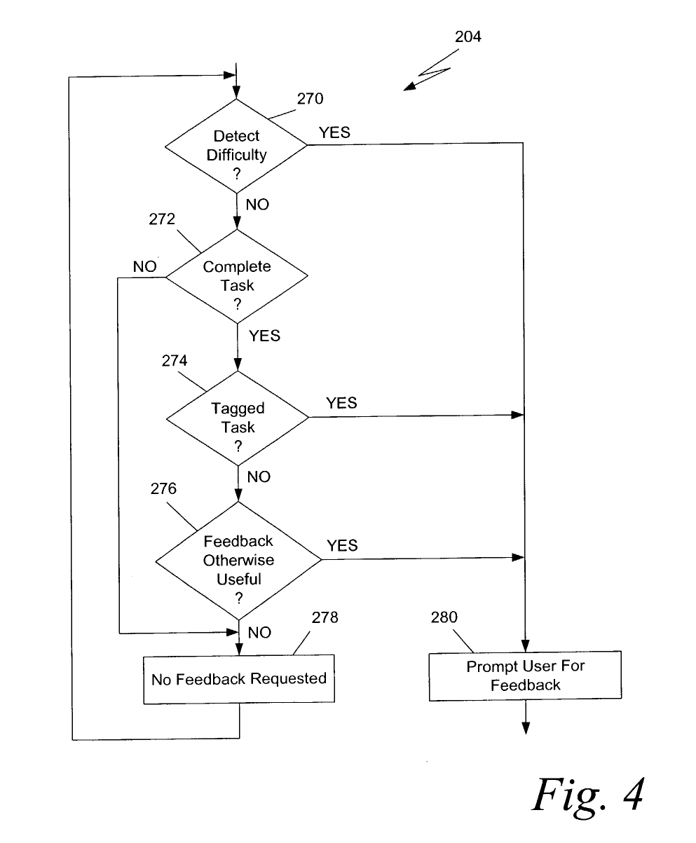

FIG. 4 shows a flow chart of one implementation of the step of requesting feedback from the user 204, shown in FIG. 3. In the example of FIG. 4, feedback is requested in three separate situations: when the user 12 encounters difficulty with the website, when the user 12 completes a “tagged” task, and when the user 12 completes a task that is not tagged but feedback would otherwise be useful. In the example of FIG. 3, the system determines whether the user 12 encountered difficulty 270 using the website during the current session. The user's interactions with the website are monitored to recognize when the user encounters difficulty with the website. For example, if the user 12 attempts the same transaction multiple times or repeatedly views the same few pages on the website, this may indicate that the user 12 has encountered difficulty with the website. In this embodiment, the user 12 is prompted for feedback 280 after detecting the difficulty (“yes” branch at 270).

In one embodiment, the website presentation layer 14 includes a GUI comprising one or more linked pages. The GUI includes a box or other icon that may be selected by the user 12 to initiate feedback when the user 12 becomes frustrated with the website. In this embodiment, the system 10 determines that the user has encountered difficulty (“yes” branch at block 270) upon receiving the user's selection of the feedback icon on the GUI.

In one embodiment, the system 10 uses usage models to predict how users or groups of users will interact with the website. For example, a model might include data for the number of pages of a website accessed by the user 12, the course of traversal of linked pages, the duration spent on the website and on individual pages, etc. The model might include average values for these parameters and/or ranges. By way of example, a user whose usage of the website falls far outside the average usage patterns might indicate to the system that the user is encountering difficulty. For example if an average user of a website spends two minutes to complete a transaction and accesses 10 pages of the website, a user who has accessed the website for 15 minutes without completing a transaction might indicate to the system 10 that the user is having difficulty, as might a user who accesses 100 pages without completing a transaction.

Also in the example of FIG. 4, feedback is requested 204 upon completion of certain tasks by the user 12. For example, if the website offers car rental reservation services, the user 12 may be prompted to enter feedback upon completing the reservation process. In the example of FIG. 4, the system automatically requests feedback following completion of certain tasks, referred to as “tagged” tasks. A “tagged” task refers to any task that has been pre-selected as requiring feedback. This embodiment allows the service provider to configure the feedback system by identifying certain tasks that always request feedback upon completion. As shown in FIG. 4, if the user 12 has not completed a task (“no” branch at block 272) then the system 10 does not request feedback 278. When the user 12 has completed a task (“yes” branch at block 272), the system 10 determines whether the task is a tagged task 274. If the task is a tagged task (“yes” branch at block 274), then the user 12 is prompted for feedback 280.

If the completed task is not a tagged task (“no” branch at block 274), then feedback is still requested under certain circumstances in the example of FIG. 4. The system 10 determines whether feedback would otherwise be useful upon completion of the untagged task 276. For example, feedback might be useful for the system 10 to add user data to the user's profile, if the user profile is incomplete. In one embodiment, user feedback is stored as user data in the user profile. Each user's feedback may be used to customize the website to the user's preferences or to otherwise better understand the user in order to better serve the user 12. Feedback might be desirable to complete user profiles for users whose profiles are incomplete, or to refine or update profiles for users who have not recently provided feedback. In FIG. 4, if the system 10 determines that feedback would otherwise be useful (“yes” branch at block 276) upon completion of an untagged task, the user is prompted for feedback 280. If feedback would not be otherwise useful (“no” branch at block 276) upon completion of an untagged task, then the user 12 is not prompted for feedback 278.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

In the claims:

1. A method of processing feedback from a user of a website, the method comprising:
receiving feedback from the user, wherein the feedback relates to a current session of use of the website by the user;
diagnosing a problem related to the feedback;
determining compensation for the problem; and
compensating the user based on the determining.

2. The method of claim 1, wherein the step of receiving feedback comprises receiving feedback during the current session.

3. The method of claim 1, further comprising requesting the feedback from the user by prompting the user for the feedback upon completion of a task by the user.

4. The method of claim 3, wherein the step of prompting the user for feedback upon completion of the task comprises:
determining whether the task is a tagged task; and
if the task is a tagged task, prompting the user for the feedback, and
if the task is not a tagged task,
analyzing a user profile for the user to determine whether the feedback from the user would be useful; and
prompting the user for the feedback based on the analyzing.

5. The method of claim 1, further comprising:
detecting difficulty encountered by the user during the current session; and
prompting the user for the feedback upon detecting the difficulty.

6. The method of claim 1,
further comprising:
determining whether the feedback is negative; and
determining whether the feedback is valid, and
wherein the step of diagnosing comprises diagnosing the problem only if the feedback is negative and valid.

7. The method of claim 1, further comprising acknowledging the feedback.

8. The method of claim 1, wherein the step of determining the compensation comprises:
assessing a cost of the problem to the user;
determining whether the cost exceeds a threshold value; and
if the cost exceeds the threshold value, proposing the compensation to the user.

9. The method of claim 1, wherein the step of determining the compensation comprises retrieving user data for the user and determining the compensation based on the user data.

10. The method of claim 9, wherein the step of determining the compensation comprises:
determining a value of the user to the website; and
determining the compensation based on the value.

11. The method of claim 1, further comprising gathering the user data based on actions by the user while connected to the website.

12. The method of claim 1, further comprising storing service management data related to the current session, and wherein the step of diagnosing comprises analyzing the service management data.

13. The method of claim 1, wherein the website includes a graphical user interface (GUI) that includes a feedback mechanism that allows the user to initiate feedback, and further comprising prompting the user for feedback in response to a selection by the user of the feedback mechanism.

14. The method of claim 5, wherein the step of detecting difficulty comprises:
comparing interaction between the user and the website with a usage model; and
determining whether the interaction deviates from the usage model.

15. The method of claim 1, wherein the step of diagnosing the problem comprises analyzing service management data for the current session to identify error messages.

16. A computer-readable medium having computer-executable instructions for performing a method for processing feedback from a user of a website, the method comprising:
collecting service management data from a current session of use of the website by the user;
receiving feedback from the user based on the current session;
diagnosing a problem related to the feedback using the service management data; and
determining compensation of the user for the problem, based on a user profile of the user, wherein the user profile indicates a value of the user to the website, and wherein the step of determining compensation comprises determining compensation based on the value of the user to the website.

17. The medium of claim 16, wherein the method further comprises compensating the user by promising the user improved future service.

18. The medium of claim 17, wherein the step of promising comprises changing terms of a service level agreement (SLA) associated with the user to provide the user higher quality service for future sessions with the website.

19. A computer-based website accessible by users via a network, wherein the website executes instructions for performing a method of compensating a user of the website based on feedback reported by the user relating to problems encountered by the user during a current session of website use, the method comprising:
receiving feedback from the user, wherein the feedback relates to a current session of use of the website by the user;
diagnosing a problem related to the feedback; and
determining compensation for the problem, wherein the step of determining comprises:
assessing a cost of the problem to the user;
determining whether the cost exceeds a threshold value; and
proposing compensation to the user if the cost exceeds the threshold value.

20. The website of claim 19, wherein the method further comprises:
determining whether the feedback is intentionally invalid; and
if the feedback is intentionally invalid, reporting the feedback as potential fraud.
